(19) United States
(12) Patent Application Publication
(10) Pub. No.: US 2004/0215357 A1
(43) Pub. Date: Oct. 28, 2004

(54) Operating terminal, particularly for automation

(75) Inventors: Herve Dallet, Brie (FR); Jean-Marie Nebout, Garat (FR)

Correspondence Address: PARKHURST & WENDEL, L.L.P., 1421 PRINCE STREET, SUITE 210, ALEXANDRIA, VA, 22314-2805, US

(73) Assignee: Schneider Elec. Industries SAS, Rueil-Malmaison (FR)

(21) Appl. No.: 10/829,457

(22) Filed: Apr. 22, 2004

(30) Foreign Application Priority Data
Apr. 22, 2003 (FR) 03 04 909

(51) Int. Cl. G05B 11/01; G05B 15/00

(52) U.S. Cl. 700/83; 700/17; 700/19

(57) ABSTRACT

Operating terminal for a system of devices or a machine, particularly for an automation system, comprising a display used in non-graphic mode, and function keys and a scroll device.

The display 13 defines one or two Boolean control actions, particularly to the left and right, with symbols Sa, Sb associated with the text. Each symbol comprises an arrow Fa, Fb and a symbol associated with a Boolean control action (20a, 20b). A side key 16a, 16b is associated with each symbol to apply a control action to the automatic control, this action possibly being held or single pressed in the case of a Boolean control, or possibly dual by using the left and right controls.

The terminal can provide a large number of control functions using a display with a small number of lines and only two function keys, while maintaining easy dialogue.

This invention relates to an operating terminal for a system of devices or a machine, particularly for an automated system of the type with a display and browse and function keys.

In particular, the purpose of this type of terminal is to make an operator dialogue with the automated system, for example for diagnostic or control purposes. The display specific to the terminal is simple and inexpensive because it may be non-graphic, and is suitable for displaying pages that are organised according to at least one menu and that are composed of text lines with alphanumeric characters for use for the operator's dialogue with the automated system. These terminals are known as XBT Magelis, Telemecanique series.

Dialogue terminals between an operator and an automated or communication system for industrial, telephone or bank terminals, often need to be very compact. This is true firstly for the display and secondly for the keys. Thus, the display can only display a small number of lines and this difficulty is circumvented by systematically scrolling lines using scroll keys, while allowing browsing among pages to be viewed using browse keys.

The size is reduced by using the smallest possible number of keys, and assigning a variable function to these keys. This assignment is made either by changing this function by pressing another key (shift), or by placing keys along at least one side of the display and assigning an automatically changing function to them depending on the steps in the dialogue or the process, the key functions then being displayed on the display facing the corresponding keys (for example, see documents EP 133 397 and WO 01/67191). Known terminals need to be simplified, while remaining suitable for the operation of a wide range of automation equipment.

In particular, the purpose of the invention is to enable an operator to use a large number of control functions in a terminal of the above mentioned type, with a small number of keys, and to dialogue intuitively and appropriately to the Boolean nature of a very wide range of automated system controls.

The invention relates to a terminal of the type comprising a screen display used in non-graphic mode suitable for displaying pages organised in menus and composed of lines to be used for dialogue between an operator and the system, particularly for surveillance, diagnostic and control purposes. The terminal comprises at least one scroll device and function keys, the text pages comprising symbols placed in the lines and denoting function keys, the scroll device being useable by the operator to select a line; and the terminal comprises a dialogue application created by the operator and comprising dialogue data that can be displayed on lines in text form using alphanumeric characters, and internal software capable of processing dialogue data and managing the display process.

According to the invention, at least one line displayed on the display defines two Boolean control actions applicable to at least one automation device, the line containing two symbols representing corresponding Boolean control actions, and two function keys on the left and right sides of the display that could be unambiguously designated by the Boolean control action symbols, and can be pressed by the operator to perform either of the two control actions specific to the line.

The control action and the associated symbols may also be of the transfer type or of the increment/decrement type, thus being quite suitable for taking action on the automation system. Selecting the line may cause selection of the two left and right control action symbols, each control action attached to a symbol being triggered by pressing the corresponding left or right function key. It is advantageous if at least one of the text lines is composed of a left part and a right part defining two corresponding Boolean control variables applicable to one component in the automation system, and if the corresponding two control action symbols are representative of dual functions (on-off, set-reset, etc.) of the component.

Preferably each action symbol comprises an arrow pointing towards the left or towards the right, and function keys are arranged on the side of the screen and arrows are marked on them in the same direction as the adjacent arrow. It is interesting if selecting a line determines the display of visual attributes specific to the control action symbol(s).

The control action symbol is advantageously representative of the current state of the Boolean variable to which the control action is applicable. The Boolean control action triggered by pressing the function key may be of the held type or the single press type, in analogy to actuation by a latching push-button or a single press button.

When at least one line presented on the display defines a browsing action, and a browse symbol appears on it, the internal software assigns a browse function to the function keys when the corresponding line has been selected by the scroll device. Preferably, no lines with control action symbols will be selected when a page is displayed, since a control action cannot be activated until the corresponding line has been selected using the scroll device.

Other characteristics and advantages will become clear in the following detailed description with reference to an embodiment given as an example and represented by the appended drawings.

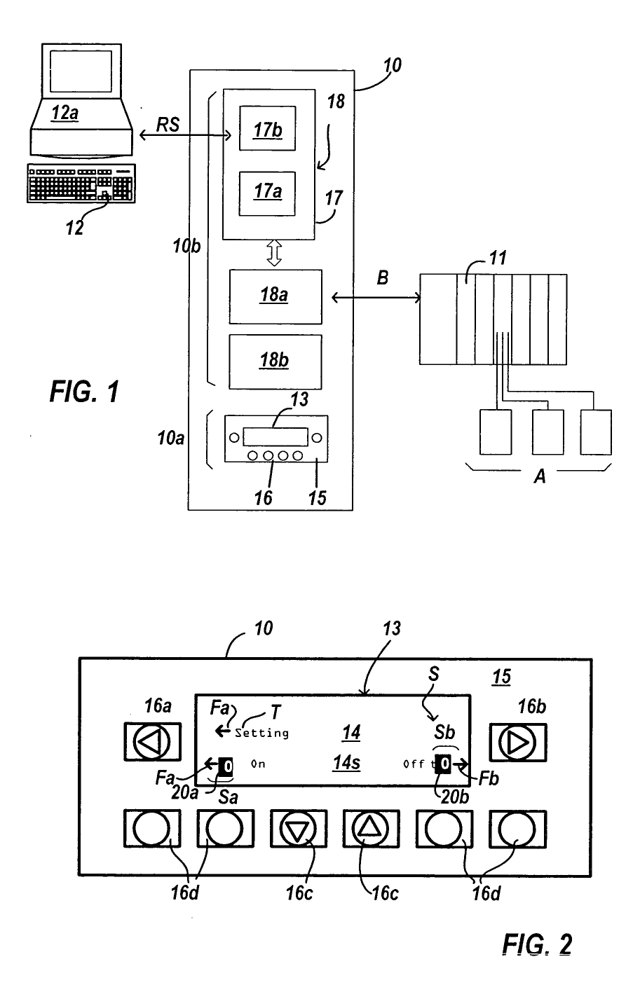

FIG. 1 diagrammatically shows automation equipment provided with an operating terminal according to the invention.

FIG. 2 shows the display and the dialogue area in an example embodiment of the terminal.

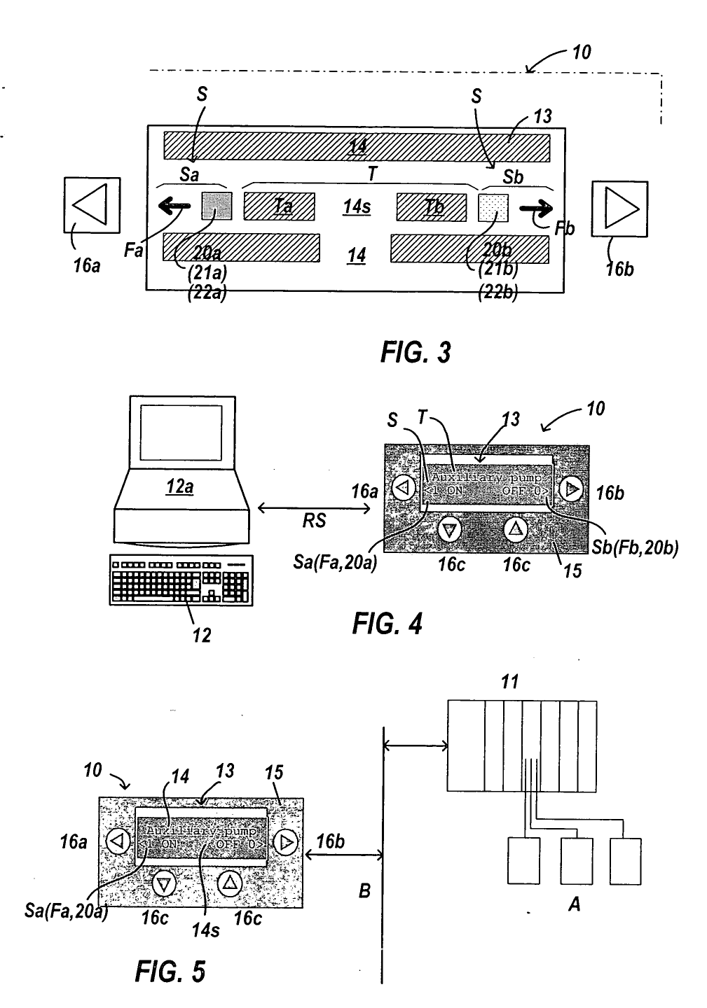

FIG. 3 diagrammatically illustrates a display example.

FIG. 4 illustrates the creation phase for the terminal dialogue application.

FIG. 5 illustrates the operating phase of the terminal.

The automation equipment illustrated in FIG. 1 comprises an operating terminal 10 according to the invention that can operate in an operating mode and in an application creation mode. In operating mode, the terminal is connected through a connection B, particularly in the form of a communication protocol commonly used in such equipment, to a device controlling the equipment, for example a programmable controller 11 itself connected to devices A. In application creation mode, the terminal 10 is connected to a personal computer (PC) 12 or a similar station through a serial link RS.

The terminal 10 comprises a hardware part 10a and a software part 10b; the hardware part 10a comprises a central unit, a memory necessary for its operation, a non-volatile memory for memorising data and the program, and a display 13 with a non-graphic screen, in other words suitable for displaying several lines 14 with alphanumeric characters (see FIG. 2), and a set of keys 16 arranged on an area 15 of the terminal adjacent to the display. A non-graphic screen can mean a purely non-graphic screen or a graphic screen used in non-graphic mode. The capacity of each displayed line is arbitrary, for example 20 characters, 40 characters or any required number of characters compatible with the required size and compactness of the terminal.

The software part 10b of the terminal comprises a manufacturer software sub-assembly 17 with a BIOS operating module 17a capable of managing the entire hardware part 10a, a loading software 17b, and an application software sub-assembly 18 including a runtime software 18a and a data set 18b corresponding to the application written by the operator. For simplification reasons, the references given indicate software involved, and also memory areas in which this software is located in the terminal.

The lines 14 presented on the display 13 consist of a text T and at least one control action symbol S. According to the invention, each line 14 may define dual control actions to be executed by the same automation device (for example “start” and “stop” a conveyor) or Boolean actions to be executed by two automation devices related to the same automation function (for example “cabinet 1” and “cabinet 2” for a “lighting” or “ventilation” function), making use of the dual text and symbols. The control action symbol S includes an arrow symbol F and, depending on the lines 14 considered, it may comprise a Boolean control action symbol 20, a transfer action symbol 21, an increment/decrement action symbol 22 or a browse action symbol. The arrow symbol F is preferably to the left or right of the text T and it may be pointing in the left direction or the right direction to unambiguously denote a corresponding function key, as will be described later.

When the action is a Boolean control action, the symbol is a Boolean control action symbol 20 that is intended to change the Boolean state of a device A of the system. For example, the symbol 20 then comprises the value “0” or “1” representing the current state of the device A.

Apart from described Boolean control actions, transfer control actions, or increment/decrement control action may be provided, using the left/right location of the keys and the corresponding symbols marked with arrows.

When the action is a transfer control action, the symbol is a transfer control action symbol 21, and it includes an appropriate designation, for example Avow The purpose of this type of control action is to load a previously memorised constant or modifiable numeric value and to transfer it to a variable in the automation system. When the action is an increment/decrement control action, the symbol is an increment or decrement indicator and it comprises an appropriate designation, for example a / sign to increment or a \ sign to decrement. The purpose of this type of action is to increment or decrement the value of a variable in the automation system.

The control action may be a browse action at some stages, and the symbol may advantageously be coincident with the above mentioned arrow symbol F. This type of browse action is intended to trigger display of a page other than the current page, depending on the organisation of pages in menus.

FIG. 2 shows the terminal 10 in more detail with its keys 16 arranged close to the display 13 on the area 15 surrounding the display. The keys 16 include a function key 16a (at the left), a function key 16b (at the right), scroll keys 16c and service keys 16d. The two function keys 16a, 16b are preferably located at the left and right, each close to a small side of the display, but they may also be located slightly below the display to the left and right. The two scroll keys 16c are located under the large side of the display and are used to select a line currently displayed on the screen by scrolling up or down. The keys 16c may be replaced by a single scroll device. The keys or the device 16 scroll towards the required lines on the page, if the page to be displayed contains more lines than can be displayed on the screen.

It should be observed that the keys 16a, 16b are dynamically assigned so that they can be used for a Boolean function, a transfer function or an increment/decrement function as required by the programming for the different lines. The keys 16a, 16b are also used for browsing in the menu. The four service keys 16d are located under the large side of the display, in line with the browse keys. These service keys may be dedicated to Validate, Select mode, Erase character commands, etc, in a well-known manner.

FIG. 2 shows an example of a screen page with three lines. An appropriate line selection is provoked by scrolling through lines on the page using one of the keys 16c, which modifies the visual appearance of the line on the display, preferably by a visual attribute applied to the symbol S. Pages can be changed by browsing in the menu; this type of change is controlled by pressing one of the function keys, in this case the left function key 16a designated by a browse action symbol marked with an arrow Fa at the left.

For example, a motor command can be produced after scrolling to select the corresponding line 14s, by activating the “on” or “off” function of the motor obtained by pressing the key 16a or 16b denoted by arrow Fa or Fb of a left symbol Sa or a right symbol Sb. The left action symbol 20a and the right action symbol 20b of the line 14 are assigned a visual attribute, and for example may change to flashing inverse video when line 14s has been selected, so that the selected state of a line can be easily identified. Instead of the Boolean symbols 20a, 20b illustrated in FIG. 2, they could be transfer symbols 21a, 21b, increment/decrement symbols 22a, 22b or browse symbols then composed of the arrows Fa, Fb.

In one embodiment preferred for its extreme simplicity, the text T and the control action symbols S may thus be represented exclusively in the form of ASCII characters (see FIGS. 3 and 4 and tables I to V), the arrow symbols then being composed of the ASCII character < or >.

The screen illustrated in FIG. 3 shows the different lines 14 that are presented on the display 13. Assuming that a median line 14s has been selected, and that the text T for this line comprises a left text part Ta and a right text part Tb, the corresponding symbols S comprise an arrow Fa at the left towards the adjacent key 16a, and a control action symbol 20a (or a transfer symbol 21a, or an increment/decrement symbol 22b) and an arrow Fb at the right pointing towards the adjacent key 16b, and a control action symbol 20b (or a transfer symbol 21b or an increment/decrement symbol 22b).

FIG. 4 illustrates the mode that the operator used to create an application; the terminal 10 is connected by a serial link RS to a personal computer 12. The personal computer uses a configuration software 12a specific to the family of terminals to which the terminal 10 belongs, such that the operator can select the terminal type and communication protocol required in corresponding tables, and can write the contents of the different menu screens that he has designed, specifying the nature of the actions (browse, Boolean control, transfer control, increment/decrement control) associated with the various lines. The application is transferred into the application memory area 18 of the terminal once it has been debugged.

FIG. 5 illustrates the operating mode of the terminal. In this mode, the operator selects the required text line 14s in a screen using keys 16c, and the action symbols S for this line are then assigned a specific visual attribute, for example by changing to flashing inverse video display. If the nature of the targeted line or part of line is “browse action”, pressing the left function key 16a or the right function key 16b will cause the display of a page pointed at by the arrow according to the menu organising the pages. If the nature of the selected line or part of line is “control action”, pressing the key will switch the targeted device (Boolean control), or load a value of an automation variable (direct write control), or modify a value of an automation variable (increment/decrement control). Only one line can be selected at any one time. When one line defines two control actions, selecting the line causes simultaneous selection of two control actions and each action is triggered by activating the corresponding function key.

Preferably, when a page is displayed, there is no selected command line and a control action cannot be activated until a corresponding line 14s has been selected using the scroll device 16c. This gives better control security.

Tables I to IV illustrate different examples of how control symbols are used.

Example I

The automation equipment comprises actuators that may be controlled using a Boolean variable but for which two buttons are necessary, for example in the case of starting a motor or a dangerous actuator (table I below).

TABLE I

| | |
|---|---|
| page displayed with different actuators that can be controlled. Line 14s << conveyor No. 2>>is selected. | 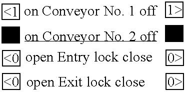 |
| press the scroll device 16c (down) to select the next ac- tuator (entry lock). | 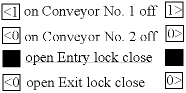 |
| press left key 16a to control opening of the <<entry lock>>. (SET action) | 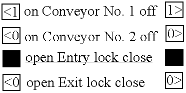 |
| 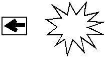 | |
| release the key 16a | 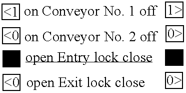 |
| to close the <<entry lock>>, press the right key 16b (RESET action) | 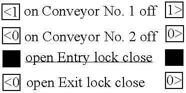 |
| 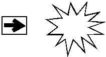 | |

Example II

The automation equipment comprises bistable actuators necessitating two Boolean variables, for example in the case of a jack with a bistable solenoid valve. The Boolean control is actuated by a single press, such that the duration of the control and the duration of the display of the symbol state are always the same regardless of the time during which the function key associated with the symbol is pressed. Each of the two symbols acts on a distinct variable, for each actuator.

TABLE II

| | |
|---|---|
| page displayed with the dif- ferent actuators that can be controlled. line 14s <<clamp No. 2>> is se- lected | 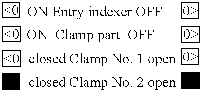 |
| press the scroll device 16c (up) to select the previous actuator (clamp No. 1). | 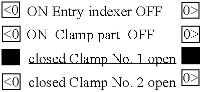 |
| press the left key 16a to control closing of <<clamp number 1>>. | 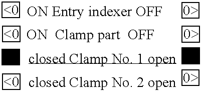 |
| 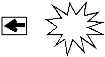 | |
| the variable associated with | |
| the left action symbol is | |
| equal to 1 as long as key 16a | |
| is pressed. | |
| release key 16a; the variable associ- ated with the left action symbol re- turns to 0 | 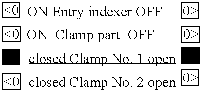 |
| press the right key 16b to open <<clamp No. 1>> | 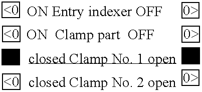 |
| 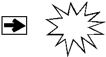 | |
| the variable associated with | |
| the right action symbol is | |
| equal to 1 as long as key 16b | |
| is pressed. | |

Example III

The automation equipment comprises monostable actuators with a single button, for example lighting commands for jacks with a spring return. Function keys act as latching buttons (push-push). Each Boolean control action symbol acts on a distinct variable.

TABLE III

| | |
|---|---|
| displayed page showing the various possible actions. The “cabinet 1 or 2 ventila- tion” line is selected so that ventilation of those two cabinets can be controlled. | 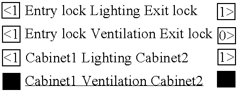 |
| press the scroll device (up) to select line 14s “cabinets 1 and 2 lighting”. | 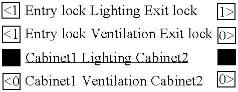 |
| press the left key 16a to switch lighting of cabinet 1 off. | 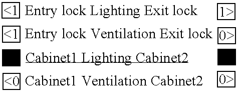 |
| 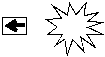 | |
| press scroll device 16c (up) to select the lock ventila- tion command. | 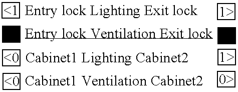 |
| press the right key 16b to start ventilation of the exit lock. | 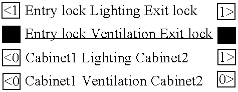 |
| 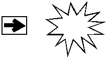 | |

Example IV

The automation equipment includes devices for which the position, speed and threshold need to be adjusted. The transfer action symbols 21 represent an increment function (left) and a decrement function (right). The two symbols act on the same variable for each setting. The function keys behave like single press control buttons, as in example II. The text in line 14s contains the adjusted value.

TABLE IV

| | |
|---|---|
| displayed page with the vari- ous possible settings. In this case, the <<entry lock temperature>> is selected. | 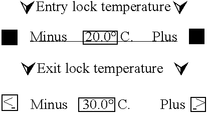 |
| press the scroll device 16c (down) to select the next setting (exit) lock tempera- ture). | 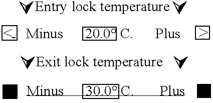 |
| press the right key 16b to increment the value of the variable. | 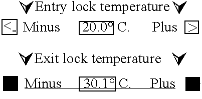 |
| 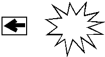 | |
| the action symbol indicates | |
| that incrementing continues | |
| as long as key 16b is | |
| pressed. | |
| release key after a few increments. | 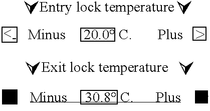 |
| press the left key 16a to decrement the value of the variable. | 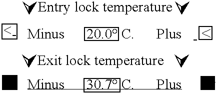 |
| 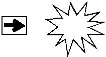 | |
| the action symbol indicates | |
| that decrementing is taking | |
| place as long as the left key | |
| 16a is pressed. | |

1. Operating terminal for a system of devices or a machine, particularly for an automation system, comprising:
a display (13) with a screen used in non-graphic mode, capable of displaying pages organised in menus and composed of lines (14) for use for the operator's dialogue with the system, particularly for surveillance, diagnostic and control purposes,
at least one scroll device (16c) and function keys (16), the text pages comprising symbols (S) placed in the lines (14) and denoting function keys,
the scroll device (16c) is useable by the operator to select a line (14),
a dialogue application created by the operator and comprising dialogue data that can be displayed on lines (14) in text form (T) using alphanumeric characters and internal software (18) capable of processing dialogue data and managing the display process,
characterised by the fact that:
at least one line (14) displayed on the display (13) defines two Boolean control actions applicable to at least one automation device, the line containing two corresponding symbols (Sa, Sb) representing Boolean control actions,
two function keys (16a,16b) on the left and right sides of the display that could be unambiguously designated by the Boolean control action symbols (Sa, Sb), and can be pressed by the operator to perform either of the two Boolean control actions specific to the line (14s), after the corresponding line (14s) has been selected.

2. Terminal according to claim 1, characterised by the fact that selecting the line (14s) causes selection of the two control action symbols (Sa, Sb) , each control action attached to a symbol being triggered by pressing the corresponding function key (16a,16b).

3. Terminal according to claim 1, characterised by the fact that at least one of the text lines (14) is composed of a left part and a right part, defining two corresponding dual control actions, and the corresponding two control action symbols (Sa, Sb) are representative of dual functions of the same component (A) in the system of devices.

4. Terminal according to claim 1, characterised by the fact that selecting a line (14s) determines the display of a visual attribute specific to the control action symbol(s) (Sa, Sb).

5. Terminal according to claim 1, characterised by the fact that the control action symbol (20a,20b) is representative of the current state of the Boolean variable to which the control action is applicable.

6. Terminal according to claim 1, characterised by the fact that the Boolean control action triggered by pressing the function key (16a,16b) is of the held type or the single press type.

7. Terminal according to claim 1, characterised by the fact that the Boolean control action triggered by pressing the function key (16a,16b) is of the set type or the reset type.

8. Terminal according to claim 1, characterised by the fact that apart from a Boolean control action, a transfer action, or an increment/decrement action are provided, and the control action symbol (S) is then a transfer action symbol (21) or an increment/decrement control action symbol (22).

9. Terminal according to claim 8, characterised by the fact that, when the control action is of the increment or decrement type, the left (16a) function key is associated with increment and the right (16b) function key is associated with decrement.

10. Terminal according to claim 8, characterised by the fact that, when the control action is of the transfer or increment/decrement type, a specific display is attached to the corresponding symbol while the action is being carried out.

11. Terminal according to claim 1, characterised by the fact that when a page is displayed, no lines with control action symbols will be selected, a control action cannot be activated until the corresponding line (14s) has been selected using the scroll device (16c).

12. Terminal according to claim 1, characterised by the fact that action symbols (S) and texts of lines (14) are composed exclusively of ASCII characters.

13. Terminal according to claim 1, characterised by the fact that each action symbol (S) comprises an arrow (Fa, Fb) pointing towards the left or towards the right, the function keys (16a,16b) being arranged on the side of the screen and arrows are marked on them in the same direction as the adjacent arrow (Fa, Fb).

14. Operating terminal for a system of devices or a machine, particularly for an automation system, comprising:
a display (13) with a screen used in non-graphic mode, capable of displaying pages organised in menus and composed of lines (14) for use for the operators dialogue with the system, particularly for surveillance, diagnostic and control purposes,
at least one scroll device (16c) and function keys (16), the text pages comprising symbols (S) placed in the lines (14) and denoting function keys,
the scroll device (16c) is useable by the operator to select a line (14),
a dialogue application created by the operator and comprising dialogue data that can be displayed on lines (14) in text form (T) using alphanumeric characters and internal software (18) capable of processing dialogue data and managing the display process,
characterised by the fact that:
at least one line (14) displayed on the display (13) defines two control actions applicable to an automation device, these actions being Boolean control actions, or increment/decrement control actions, depending on the line considered, the line comprising two corresponding symbols (Sa, Sb) on the left and right and representing control actions,
two function keys (16a,16b) on the left and right sides of the display that could be unambiguously designated by the control action symbols (Sa, Sb), and can be pressed by the operator to perform either of the two control actions specific to the line.
